(19) United States
(12) Patent Application Publication
(10) Pub. No.: US 2013/0209731 A1
(43) Pub. Date: Aug. 15, 2013

(54) METHOD AND DEVICES FOR CREATING A MULTIPLICITY OF HOLES IN WORKPIECES

(71) Applicants: Kurt Nattermann, Ockenheim (DE); Ulrich Peuchert, Bodenheim (DE); Wolfgang Moehl, Worms (DE); Stephan Behle, Gau-Odernheim (DE)

(72) Inventors: Kurt Nattermann, Ockenheim (DE); Ulrich Peuchert, Bodenheim (DE); Wolfgang Moehl, Worms (DE); Stephan Behle, Gau-Odernheim (DE)

(73) Assignee: SCHOTT AG, Mainz (DE)

(21) Appl. No.: 13/807,391

(22) PCT Filed: Jul. 4, 2011
(86) PCT No.: PCT/EP11/03301

§ 371 Date: Feb. 28, 2013

(30) Foreign Application Priority Data
Jul. 2, 2010 (DE) 10 2010 025 967.5

(51) Int. Cl. C03B 33/09

(52) U.S. Cl. CPC C03B 33/093
USPC 428/131; 65/112; 65/23; 65/30.1; 65/166

(57) ABSTRACT

Methods and apparatuses for producing a multiplicity of holes in thin workpieces made of glass or glass-like materials and semiconductors are provided. The method includes directing multiple laser beams onto predetermined perforation points of the workpiece in a wavelength range between 1600 and 200 nm and with a radiation intensity that causes local non-thermal destruction of the workpiece material along respective filamentary channels. Subsequently, the filamentary channels are widened to the desired diameter of the holes.

### FIELD OF THE INVENTION

The invention relates to methods for producing a multiplicity of holes in workpieces in form of thin sheets and substrates of glass and glass-like materials and semiconductors, and further relates to apparatus for carrying out the methods and to a product produced by such methods.

### BACKGROUND OF THE INVENTION

The perforation of plastic films by electrically generated sparks is known from U.S. Pat. No. 4,777,338. A plurality of electrode-counter electrode pairs is provided, between which the plastic film is guided and across which high-voltage energy is discharged. The film is moved through a water bath, and the temperature of the water bath is utilized to control the size of the perforations.

Another method for producing pores in plastic films is known from U.S. Pat. No. 6,348,675 B1. Pulse sequences are generated between electrode pairs, with the plastic film interposed therebetween, the first pulse serving to heat the plastic film at the perforation point and the further pulses serving to form the perforation and to shape it.

From U.S. Pat. No. 4,390,774, the treatment of non-conductive workpieces by electrical means is known in the sense of cutting the workpiece or welding the workpiece. A laser beam is directed onto the workpiece which is moved during the exposure, and a high-voltage is applied to the heated zone using two electrodes to form an arc which serves to process the workpiece. During cutting of the workpiece it burns in controlled manner, or electrical conductivity thereof increases with temperature, similarly to the cutting of glass. When workpieces are to be welded, streams of reactive or inert gas are additionally directed to the heated zone to react with either the workpiece or the electrode or a fluxing agent. In this way, glass, paper, cloth, cardboard, leather, plastics, ceramics, and semiconductors can be cut, or glass and plastics can be welded, rubber can be vulcanized, and synthetic resins can be cured thermally. However, the equipment is too clunky by its nature as to permit thin holes to be formed in the workpiece.

From WO 2005/097439 A2 a method is known for forming a structure, preferably a hole or cavity or channel, in a region of an electrically insulating substrate, in which energy, preferably in form of heat, also by a laser beam, is supplied to the substrate or region, and a voltage is applied to the region to produce a dielectric breakdown there. The process is controlled using a feedback mechanism. It is possible to produce thin individual holes one after the other, however it is not possible to employ a plurality of electrode pairs simultaneously. This is because parallel high voltage electrodes mutually influence each other and a single breakdown attracts the entire current.

From WO 2009/059786 A1 a method is known for forming a structure, in particular a hole or cavity or channel or recess, in a region of an electrically insulating substrate, in which stored electrical energy is discharged across the region and additional energy, preferably heat, is supplied to the substrate or the region to increase electrical conductivity of the substrate or region and thereby initiate a current flow, the energy of which is dissipated in the substrate, i.e. converted into heat, wherein the rate of dissipation of the electrical energy is controlled by a current and power modulating element. An apparatus for simultaneously producing a plurality of holes is not disclosed.

WO 2009/074338 A1 discloses a method for introducing a change of dielectric and/or optical properties in a first region of an electrically insulating or electrically semi-conducting substrate, wherein the substrate whose optical or dielectric properties are irreversibly altered due to a temporary increase in substrate temperature, optionally has an electrically conductive or semi-conductive or insulating layer, wherein electrical energy is supplied to the first region from a voltage supply to significantly heat or melt parts or all of the first region without causing an ejection of material from the first region, and wherein furthermore, optionally, additional energy is supplied to generate localized heat and to define the location of the first region. The dissipation of electrical energy manifests itself in form of a current flow within the substrate. The dissipation of the electrical energy is controlled by a current and power modulating element. Alterations in substrate surfaces produced by the method also include holes produced in borosilicate glass or silicon substrates which had been provided with an insulating layer of paraffin or a hot melt adhesive. Also, holes are produced in silicon, in zirconia, in sapphire, in indium phosphide, or gallium arsenide. Partially, the discharge process was initiated by laser beam irradiation at a wavelength of 10.6 μm (CO₂ laser). Grids of holes are also disclosed, but with relatively large spacings of the holes. An apparatus for simultaneously producing a plurality of holes is not disclosed.

From JP 2006 239 718 A, it is known to produce filamentary channels within transparent materials and to extend the filaments down to the bottom of the transparent material. This permits to effectively and accurately produce fine structures in the transparent material, such as glass.

DE 37 42 770 A1 describes flat membranes from foils of organic polymers, glass or ceramic materials having funnel-shaped tapering pores of defined pore size, which are manufactured using laser light, by projecting an aperture mask to the workpiece. Thus, each laser beam has associated therewith a plurality of pores in the workpiece.

Therefore, it is clear from prior art how to perforate foils and thin sheets of dielectric materials using a high voltage electric field of appropriate frequency or pulse shape. Local heating of the material reduces the dielectric strength at the points to be perforated, so that the applied field strength is sufficient to cause an electric current to flow across the material. If the material exhibits a sufficiently large increase in electrical conductivity with temperature, as is the case with glasses, glass-ceramics, and semi-conductors (also with many plastics), the result is an “electro-thermal self-focusing” of the perforation channel in the material. The perforation material is getting hotter and hotter, current density increases until the material is evaporated and the perforation is “blown open”. However, since the perforation is based on a dielectric breakdown, it is difficult to exactly match the desired location of the breakdown. As is known, flashes follow a very irregular course.

CPU chips have several hundred contact points distributed over a small area on the bottom surface thereof. In order to produce supply lines to the contact points, thin sheets (<1 mm) are used, i.e. fiberglass mats coated with epoxy material referred to as “interposers”, through which the supply lines extend. To this end, several hundred holes are placed in the interposer and filled with conductive material. Typical hole sizes range from 250 to 450 μm per hole. There should not be any alterations in length between CPU chip and interposer. Therefore, the interposers should exhibit a thermal expansion behavior similar to that of the semiconductor material of the chip, which, however, is not the case with previously used interposers.

What is also lacking in the prior art is the manufacturing of a multiplicity of thin holes adjacent to one another on an industrial scale, with hole-to-hole spacings ranging from 120 μm to 400 μm, and using the electro-thermal perforation process.

### GENERAL DESCRIPTION OF THE INVENTION

An object of the invention is to provide a method and an apparatus for producing a multiplicity of holes in workpieces in form of thin sheets (<1 mm) and substrates of glass and glass-like materials and semiconductors, if one or more of the following requirements have to be met:
It has to be possible for the holes to be positioned exactly (±20 μm).
It has to be possible to produce many (10 to 10,000) small holes per workpiece with tight hole-to-hole tolerances.
It has to be possible to produce the holes with a narrow hole-to-hole spacing (30 μm to 1000 μm).
The holes have to be producible on an industrial scale, i.e. many microholes per workpiece simultaneously.

In particular, it should be possible to produce “glass interposers” having the following properties:
They have a hole pattern with hole diameters from 20 μm to 450 μm, preferably from 50 μm to 120 μm, with aspect ratios (ratio of glass thickness to hole diameter) from 1 to 10.
The number of holes varies between 1000 and 5000.
The center-to-center distance of the holes ranges from 120 μm to 400 μm.
The shape of the holes is not ideally cylindrical, rather the edge is rounded at the inlet and outlet of the hole.
A bead around the edge of the holes with a bead height of not more than 5 μm may optionally be permitted.
The walls of the holes are smooth (fire-polished).

The method according to the invention is proceeded in two steps. First, the hole in the workpiece to be perforated is “prepared” by directing laser beams to the predetermined perforation points in order to induce non-thermal destruction in the substrate along a respective filamentary channel. Because of the transparency of the material, the laser beam penetrates into the material, and if the radiation intensity is very high the material is locally destroyed in non-thermal manner by the high field strength of the laser. This effect is intensified by optical self-focusing in transparent material. Therefore, a straight, very thin channel of destruction is produced. This allows for exact positioning of the holes. Since the damage extends along a very thin channel it is possible to produce such filamentary channels with a close spacing to one another without mutual interference of the manufacturing processes.

In a second step, the filamentary channels are widened to a desired hole diameter. In principle, this may be accomplished based on known procedures, but it is also possible to adopt innovative procedures to achieve a widening of the filamentary channels to the desired hole diameters.

According to an embodiment of the invention, starting from the surface of the sheet or substrate material, locally limited conductive regions are produced at the predetermined perforation points, which are used as micro-electrodes for a high voltage breakdown, or as micro-antennas for supplied high frequency energy to cause electro-thermal breakdowns and thus formation of the desired holes. The locally limited conductive regions may be produced by generating an ionization and forming a plasma.

The conductive regions may likewise be formed by locally printed material which is intrinsically conductive or becomes conductive through energy input.

It is also possible for the conductive regions to be made effective by heat conduction, and in such a case radiation absorbing ink may be printed to the predetermined perforation points.

The invention also relates to apparatus for carrying out the perforation method. An array of multiple lasers is provided for emitting respective laser beams in accordance with a predetermined pitch. A workpiece holder supports the sheet or substrate material to be perforated transversely to the direction of the laser beams and allows for transverse displacement and fixing of the workpiece relative to the multiple laser array. The lasers are effective in a wavelength range from 3000 to 200 nm where the sheet or substrate material is at least partially transparent to an extent that the respective laser beam penetrates into the material. Pulsed lasers are used, which attain a significant radiation intensity so that the material is locally destroyed in non-thermal manner. Absorbers/scattering centers incorporated in the material will promote this effect of locally closely limited destruction.

Once the filamentary channels have been formed there are two ways to widened them to the desired hole diameter, which ways may also be combined:
1. By using high frequency energy, heating and melting/evaporating the material along the filamentary channels, optionally promoted by combining chemical effects along the perforation walls being formed.
2. By electro-thermal breakdown along the filamentary channels caused by a high voltage, optionally with chemical/physical removal of the eroded material.

For widening the filamentary channels into the desired uniform holes, high-voltage electrodes may be used, which are disposed near the filamentary channels in mutual opposed relationship. There, the breakdown field strength of the material is reduced so that caused by an applied high voltage an electric current flows, which causes heating of the material along the filamentary channels, which in turn causes the electrical conductivity of the effected material to increase locally, with the consequence of a still higher current flow and heating in the region of the filamentary channels. This eventually results in evaporation of perforation material and formation of the desired holes in the workpiece. In order to enhance the quality of the holes or perforations in the workpiece in terms of roundness and uniformity, high-voltage electrodes which are arranged symmetrically around each perforation of the electrode holder, are switched on in a rotating and alternating pattern relative to the counter electrodes. This slows down and evens out the wear of the electrodes, so that uniformly shaped holes can be expected in the sheets or substrate materials in the long term.

Instead of using high voltage sparks to clear the holes, high frequency energy may be employed to locally heat the material in the filamentary channels. Actually, the laser beams can provide for a plasma to be formed at the predetermined perforation points which may be used as micro-antennas for high frequency energy supplied. By providing the electrode and counter electrode in a plate-like shape and by exciting them with a high frequency, electro-thermal energy can be supplied simultaneously and without mutual interference to all perforation points of the sheet or substrate material associated with the pattern of laser beams to achieve increased current flow and heating of the perforation material with evaporation and finally the desired formation of holes in the workpiece.

The generation of the filamentary channels and the widening thereof may be accomplished in different apparatus parts, but it is also possible to use combined systems.

A combined system may comprise:
a multiple laser array for emitting respective laser beams in accordance with a predetermined pitch;
a plate-shaped high-frequency electrode having apertures in correspondence to the pitch;
a plate-shaped high-frequency counter electrode having apertures in correspondence to the pitch;
a workpiece holder for displacing and fixing the sheet or substrate material to be perforated in the processing space between the high frequency electrodes;
supply and discharge channels to supply reactive gases and purge gases to the holes being formed in the material and to remove reaction products.

Another combined system may likewise include an array of multiple lasers which are arranged for emitting laser beams according to a predetermined pitch.

A plate-like electrode holder has apertures of the predetermined pitch matched to the predetermined perforation points of the sheet or substrate material. High voltage electrodes are arranged symmetrically around each perforation of the electrode holder. A counter electrode holder is arranged at a distance from the electrode holder and to form an intermediate space, and has counter electrodes at locations opposite to the electrodes. A workpiece holder supports the sheet or substrate material to be perforated within the intermediate space between electrodes and counter electrodes. The lasers may be switched on at specific times to emit laser beams to produce filamentary channels in the sheet or substrate material according to the predetermined pitch. At later times, the electrodes and counter electrodes may be switched on to cause high-voltage flashovers to produce the holes in the sheet or substrate material.

In both basic procedures, the pattern of predetermined perforation points in the workpiece may be larger than the array of respective laser beams. In such a case, the perforation pattern may be produced by displacing the array relative to the workpiece for several times. In this manner, the holes may be produced with a close spacing, although the lasers in the multiple array are not so tightly packed as would correspond to the hole spacing.

### BRIEF DESCRIPTION OF THE DRAWINGS

Exemplary embodiments of the invention will now be described with reference to the drawings, wherein:

FIG. 1 illustrates a first embodiment of producing microholes in thin sheets and substrates using high voltage sparks; and

FIG. 2 shows an apparatus for producing microholes using a high frequency energy input.

### DETAILED DESCRIPTION

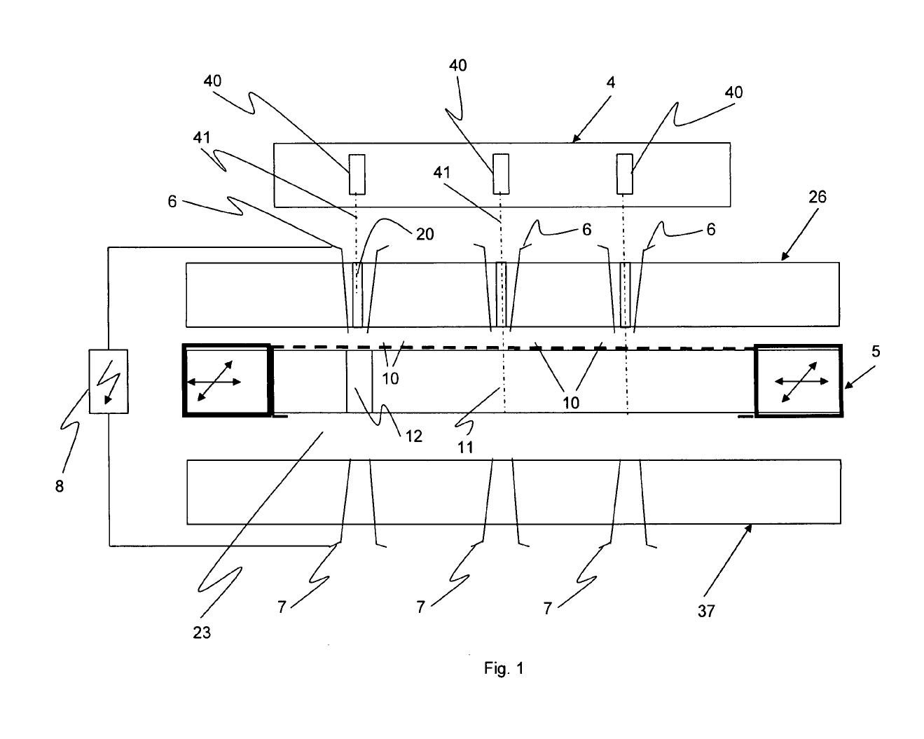

FIG. 1 is a schematic view of an apparatus for producing microholes in a sheet-like workpiece 1 of glass, glass ceramics, or semiconductor material. The workpiece is introduced in a processing space 23 between an upper plate-like electrode holder 26 and a lower plate-like electrode holder 37. Above electrode holder 26, an array 4 of lasers 40 is provided. Workpiece 1 is supported by a workpiece holder 5 which permits to adjust the workpiece 1 in very fine steps within processing space 23 between electrode holders 26 and 37. Electrode holder 26 has apertures 20 aligned with the respective beams 41 of lasers 40. Distributed in a circle around each of apertures 20, electrodes 6 are arranged, which are connected to counter electrodes 7 via one or more independent high-voltage source(s) 8. Workpiece 1 has a large number of intended perforation points 10 at which perforations 12 are to be produced. Apertures 20 in electrode holder 26 have a pitch that is matched to the pattern of perforation points 10, i.e. the pattern of perforation points 10 is a multiple of the pitch of apertures 20.

As lasers 40, lasers in a wavelength range between 3000 and 200 nm are used, specifically adapted to the respective material of the workpiece 1 which is at least partially transparent.

The wavelength range of the lasers falls into the range of transparency of the workpiece material. Therefore, the laser radiation 41 can penetrate deep into the workpiece material and is not absorbed at the surface. A pulsed laser with a short pulse duration is used, with a radiation intensity in the beam focus that is so strong that the material is destroyed in non-thermal manner by the high field strength of the laser. The effect is self-intensifying by optical self-focusing in the transparent material. Thereby, very fine filamentary channels 11 of destroyed material are formed in workpiece 1. A suitable laser for generating such filamentary channels 11 is a Nd:YAG laser having a radiation wavelength of 1064 nm and a pulse duration in the picosecond to nanosecond range. Other suitable lasers include Yb:YAG at 980 nm, Er:YAG at 1055 nm or at about 3000 nm, Pr:YAG or Tm:YAG at 1300 to 1400 nm. Partially, frequency doubling or tripling may be accomplished with these lasers.

The formation of filamentary channel 11 may be enhanced by naturally occurring or artificially introduced absorbers or scattering centers in the workpiece material 1, especially if the latter is glass. Bound water may be used as an absorber. Absorbent elements that may be used include narrow-band absorbing laser active elements such as active rare-earth ions of Ce, Pr, Nd, Sm, Eu, Gd, Tb, Dy, Ho, Er, Tm, Yb. Broad-band absorbing elements such as transition metal ions, e.g. Cr, Mn, Fe, are also useful. The lasers and absorbing elements are adapted to each other. Only extremely small amounts of the appropriate absorbers are required.

Once the filamentary channels 11 have been produced, the perforations or holes 12 are formed. In case of the specific apparatus shown in FIG. 1, this is accomplished by applying a high voltage to electrodes 6 and 7. These are arranged in symmetrically distributed manner around the respective beam direction 41 and preferably comprise three electrodes in each case. Upper electrodes 6 are switched on in rotating order, while lower electrodes 7 are switched on and off according to a random pattern or program, however in a manner so that at any time during high voltage operation one of the upper and one of the lower electrodes is switched on. The sparks run the path of least resistance along the filamentary channels 11, the introduced heat reduces the electrical resistance, current density increases, and the heating causes evaporation of the perforation material. The operation with alternately driven individual electrodes ensures that the hole 12 is formed perpendicular to the plane of the sheet and that good axial symmetry is achieved. The walls of holes 12 largely follow a cylindrical shape. Moreover, an extended service life of the highly stressed electrodes 6, 7 can be expected.

The vaporized perforation material may be sucked off from processing space 23, which is not shown in further detail. For this purpose, reactive gases may be used to convey the vapor in the gas phase and to largely avoid precipitation of material in unwanted places.

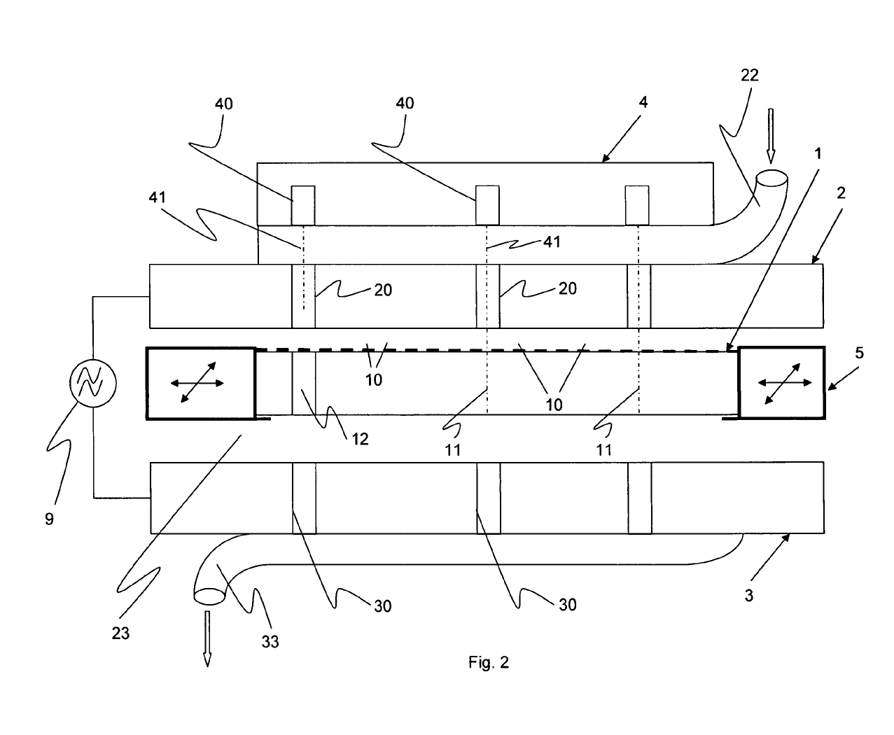

FIG. 2 shows another apparatus for producing a plurality of holes 12 in workpiece 1. Workpiece 1 is arranged in processing space 23 between two plate-shaped high-frequency electrodes 2, 3. The electrodes have mutually aligned apertures 20, 30 which form a pattern. A plurality of lasers 40 is arranged in a multiple array 4 of the same pattern, such that the emitted beams 41 are aligned to apertures 20 and 30. Workpiece 1 is seated in a workpiece holder 5 which permits exact coordinate-based displacements. In this way, the predetermined perforation points 10 of the workpiece 1 may be adjusted relative to the multiple array 4, by displacement. Plate electrodes 2, 3 can be supplied with an appropriate high-frequency voltage from high-frequency generator 9. A system of conduits and channels 22, 33 allows to feed reactive gases and purge gases through apertures 20, 30 into processing space 23 between electrodes 2, 3, and to discharge reaction products and purge gas as well as vaporized perforation material.

The operation of the apparatus is as follows:

Workpiece 1 is placed in a position so that specific predetermined perforation points 10 are aligned to apertures 20, 30. Then, lasers 40 are switched on and produce non-thermal destructions along filamentary channels 11. Simultaneously, a plasma is generated at the locations of impact of beams 41. This plasma is a kind of a conductive spot which acts as a local antenna for irradiated high frequency energy. Such high frequency energy is generated by switching on high-frequency generator 9 which causes heating of the material 1 along filamentary channels 11.

Additionally, the introduced electrical energy causes electric currents along the channels, which currents increase with increasing temperature and finally cause evaporation of perforation material. The formation of holes may be enhanced and modified by introducing reactive gas. Such reactive gas is supplied to the heated regions via supply line 22 and apertures 20. Reaction products are discharged through apertures 30 and channel 33. Purge gases provide for a cleaning of workpiece 1.

If the intended hole pattern 10 has a closer pitch than the pitch of laser beams 41, the material 1 is shifted and the process described before is repeated. This continues until all predetermined perforation points 10 have been processed. It is possible to produce thin holes with a large ratio of hole length to hole diameter, the so-called aspect ratio. There will not be any sharp edges at the inlets and outlets of the holes.

The described apparatus may be modified. For example, filamentary channels 11 may be produced in a separate apparatus, and subsequently holes 12 may be produced in another apparatus. It is also possible to prepare the sheet or substrate material 1 with respect to the intended perforation points 10. At the intended perforation points, the material may be printed with a radiation absorbing ink. This promotes local heating of the material 1, whereby starting from these points electro-thermal heating emanates which results in holes 12. For this local heating, a conventional radiation source may likewise be used instead of a laser. This is especially considered when separate manufacturing of filamentary channels 11 and holes 12 is taken into consideration. Moreover, such conventional radiation sources which are cheaper and easier to maintain than lasers permit to homogeneously illuminate large areas of the material 1. It is possible to filter out from the emitted radiation those spectral ranges in which the material 1 to be perforated is absorbent. Or, conventional radiation sources are used which only emit in narrow spectral bands for which the materials 1 to be perforated are transparent. In these cases, selective absorbers may be added to the printing inks. Moreover, the printing ink need not to be dried, since this happens anyway due to the irradiation. Ceramic colors (glass frit including absorbers and low organic binder) are also useful for marking the perforation points 10.

It is likewise useful for marking the points 10 to be perforated to apply a conductive paste. The paste acts as a local electrode, i.e. the electric field from electrodes 2, 3 couples particularly strongly to these local electrodes and produces a particularly high electric field in their local environment, so that electro-thermal heating preferably occurs in this region. Here, again, the paste need not to be dried. The paste may also contain metallic particles or may release metallic particles due to thermal and chemical processes.

For solar cells that are coated with SiN, glass frit based pastes having a content of PbO or BiO are particularly advantageously uses, since PbO and BiO, when heated, chemically react with the electrically insulating SiN layer to dissolve it. Part of the remaining Pb or BiO is reduced to conductive metallic Pb or Bi. These metal particles mark the perforation points on the workpiece from which electro-thermal formation of the holes or perforations emanates.

It will be appreciated that it is likewise possible to combine both ink and paste with electrically conductive inclusions.

To mark the perforation points, the ink and/or paste may be applied by various printing processes, for example using a screen or pad printing method, or an ink jet method.

The perforation method described has been developed for manufacturing novel interposers. Such interposers include a base substrate made of glass having an alkali content of less than 700 ppm. Such a glass has a thermal expansion factor which is close to that of silicon chips. The novel perforation method permits to produce very thin holes in a range from 20 μm to 450 μm, preferably in a range from 50 μm to 120 μm.

1-20. (canceled)

21. A method for simultaneously producing a multiplicity of holes in a workpiece formed of thin substrates of glass, glass-like materials, glass ceramics, and semiconductors, comprising the steps of:
providing the workpiece to be perforated which is at least partially transparent in a wavelength range between 3000 and 200 nm;
aligning a multiple laser beam array to predetermined perforation points of the workpiece;
triggering the array to direct focused laser pulses in the wavelength range and with a radiation intensity that causes local non-thermal destruction of the workpiece along filamentary channels corresponding to the predetermined perforation points; and
widening the filamentary channels to a desired diameter of the holes.

22. The method as claimed in claim 21, wherein the widening step comprises generating a high-voltage field at the predetermined perforation points to produce dielectric breakdowns at the predetermined perforation points.

23. The method as claimed in claim 21, further comprising:
producing locally closely limited conductive regions on a surface of the workpiece at the predetermined perforation points; and
using the conductive regions as micro-antennas to supply high frequency energy to cause electro-thermal breakdown so as to widen the filamentary channels to the desired diameter of the holes.

24. The method as claimed in claim 23, wherein the step of producing locally closely limited conductive regions comprises generating a plasma at locations of impact of the laser pulses.

25. The method as claimed in claim 24, wherein the step of generating the plasma comprises using KrF lasers with a wavelength of 250 μm or KrBr lasers with a wavelength of 209 μm.

26. The method as claimed in claim 23, wherein the step of producing locally closely limited conductive regions comprises locally printing material that is conductive or becomes conductive through energy input.

27. The method as claimed in claim 23, wherein the step of producing locally closely limited conductive regions comprises:
printing pastes with a PbO or BiO content onto an SiN layer; and
irradiating with focused laser pulses so that the pastes and SiN layer react with each other to dissolve the SiN layer thereby producing metallic Pb or Bi at the predetermined perforation points.

28. The method as claimed in claim 23, wherein the step of producing locally closely limited conductive regions comprises applying ink that absorbs radiation on the surface.

29. The method as claimed in claim 23, wherein the step of producing locally closely limited conductive regions comprises incorporating absorbers or scattering centers in the workpiece.

30. The method as claimed in claim 21, wherein the array comprises solid-state lasers and the triggering step comprises triggering the solid state laser with a pulse duration in a picosecond to nanosecond range.

31. The method as claimed in claim 21, wherein the widening step comprises using lasers in a near infrared range or in a visible radiation range for homogeneous deep heating of the workpiece.

32. The method as claimed in claim 21, further comprising incorporating a light absorbing substance into the workpiece.

33. The method as claimed in claim 21, wherein the widening step comprises employing reactive gases to promote formation of the holes.

34. A glass interposer including a base substrate made of glass having an alkali content of less than 700 ppm, and with holes produced according to the method as claimed in claim 21 and hole sizes ranging from 20 μm to 450 μm.

35. An apparatus for generating a plurality of holes in a workpiece, comprising:
a plate-shaped electrode holder and a plate-shaped counter electrode holder that enclose a processing space, the processing space being sufficient to receive the workpiece;
a workpiece holder sufficient to hold the workpiece in the processing space; and
an array of multiple lasers for emitting respective laser beams in accordance with a predetermined pitch matched to a pattern of predetermined perforation points of the workpiece, each laser beam having associated therewith one aperture in the electrode holder and one perforation point in the workpiece, each laser being sufficient to emit radiation in a wavelength range between 3000 and 200 nm to form filamentary channels in the work piece,
wherein the electrode holder has apertures of the predetermined pitch, and
wherein the electrode holder has electrodes and the counter electrode holder having counter electrodes, the electrodes and counter electrodes being sufficient to cause high-voltage flashovers to produce the holes in the workpiece at the filamentary channels.

36. The apparatus as claimed in claim 35, wherein the electrode holder has a plurality of electrodes and the counter electrode holder has a plurality of counter electrodes, the plurality of electrodes being arranged symmetrically around each aperture of the electrode holder and corresponding to the plurality of counter electrodes, and the plurality of electrodes being subjectable to a high voltage in rotating order and with an alternating pattern relative to the plurality of counter electrodes.

37. The apparatus as claimed in claim 35, further comprising a channel system in communication with the processing space, the channel system being sufficient to introduce and remove reactive gases and purge gases from the processing space to promote the formation of holes and to discharge reaction products.

38. An apparatus for generating a plurality of holes in a workpiece, comprising:
a plate-shaped high-frequency electrode and a plate-shaped high-frequency counter electrode that enclose a processing space sufficient to receive the workpiece;
a workpiece holder sufficient to hold the workpiece in the processing space; and
an array of multiple lasers for emitting respective laser beams in accordance with a predetermined pitch matched to a pattern of predetermined perforation points of the workpiece, each laser beam having associated therewith one aperture in the electrode holder and one perforation point in the workpiece, each laser being sufficient to emit radiation in a wavelength range between 3000 and 200 nm to form filamentary channels in the work piece,
wherein the high-frequency electrode has apertures of the predetermined pitch,
wherein the laser beams are sufficient to form closely limited local conductive regions at the predetermined perforation points, and
wherein the electrode and counter electrode are sufficient to, when supplied with high frequency energy, apply the high frequency energy to the conductive regions and to thereby produce the holes at the predetermined perforation points.

39. The apparatus as claimed in claim 38, wherein the electrode and counter electrode have apertures that are aligned to each other and connected to gas supply and discharge channels sufficient to remove eroded perforation material from the processing space.
